(19) United States
(12) Patent Application Publication
(10) Pub. No.: US 2019/0364848 A1
(43) Pub. Date: Dec. 5, 2019

(54) HORSE BOOT WITH ADJUSTABLE HEEL COMPONENT

(71) Applicant: EASYCARE, INC., DURANGO, CO (US)

(72) Inventor: GARRETT N. FORD, DURANGO, CO (US)

(73) Assignee: EASYCARE, INC., DURANGO, CO (US)

(21) Appl. No.: 16/425,928

(22) Filed: May 29, 2019

Related U.S. Application Data
(60) Provisional application No. 62/680,629, filed on Jun. 5, 2018.
(60) Provisional application No. 62/748,509, filed on Oct. 21, 2018.

(51) Int. Cl. A01K 13/00; A01L 3/04

(52) U.S. Cl. CPC A01K 13/007; A01L 3/04

(57) ABSTRACT

A horse boot comprises a shell with front and lateral sidewalls. The sole has a longitudinal slot and an open rear end for access to the slot. The slot may be open or closed. A heel support includes a bottom plate for slidable engagement with the slot at a desired length position. Straps wrap around the hoof and connect the heel support to the shell of the boot. The heel support comprises a back plate and a heel cradle slidably coupled to the back plate for vertical adjustment. Straps extend forward attached to the front portion of the shell. In another embodiment a heel cradle structure includes bands fastened to the rear of the shell, thereby defining bulb retaining openings. A strap wrapped around the hoof is attached to the bands. The boot is fitted adjusting length and height to optimize the way it is fastened to the hoof.

### RELATED APPLICATIONS

This application is based on and claims the priority of provisional application Ser. No. 62/680,629, filed Jun. 5, 2018, and application Ser. No. 62/748,509, filed Oct. 21, 2018, hereby both incorporated by reference.

### BACKGROUND OF THE INVENTION

### Field of the Invention

The invention relates in general to boots for horses and, in particular, to a boot that includes an adjustable heel component designed to accommodate different-size hooves and prevent detachment of the boot due to its deformation and/or interference with other boots worn by the horse during use.

### Description of the Prior Art

Horse boots are used to protect the hooves and fetlocks of horses and are often used in lieu of horseshoes. The shell of a horse boot typically includes a sole with a flat top surface that meets the underside of the hoof and an upper that projects upward from the sole and forms a peripheral enclosure for at least part of the hoof of the horse. The upper typically extends along at least a portion of the rim of the sole and has a bottom edge secured to the sole. A tongue is often formed in the front portion of the upper.

In a particular type of horse boot with an upper made of plastic material, the heel portion of the upper extends upward from the sole by an amount sufficient to support the back of the hoof by forming a cup-like peripheral enclosure that envelops the heel of the hoof. For a given boot, this enclosure is fixed in size and different-size hooves require different-size boots. The boot further comprises a means for fastening the shell to the horse's hoof either mechanically, via a variety of fasteners attached to the upper that strap around the pastern or the higher front portion of the hoof, or by gluing the shell to the hoof. In use, such boots are installed by spreading open the sides of the upper, slipping the boot onto the hoof from the front, and securing the shell on the hoof with the intended fastening means.

While each of the many prior-art boots defined by this general description provides advantages over other designs, they all still suffer from the undesirable lack of length-adjustment capability, which forces horse owners to own multiple boots to account for changes in hoof size between trimmings. Furthermore, with regard to boots that are fastened by mechanical means, the fasteners tend to extend enough outwardly to interfere with the normal movement of the horse's hooves during gallop, which often causes a boot to fall off when the fastener is hit by another boot. This invention provides a solution to these problems with a new design that also improves the fit of the boot on the hoof of the horse.

### SUMMARY OF THE INVENTION

The invention is a horse boot that comprises a shell that includes a sole and an upper with sidewalls extending upward from front and lateral edges of the sole, the sole having a longitudinal slot open to the back and having the upper having an open rear end for access to the slot. A heel support that includes a bottom plate is adapted for slidable engagement with the slot in the sole and a first fastener is provided for fixing the plate to the sole at a desired length position. A strap fastener is used to wrap around the hoof of the horse and connect the heel support to the shell of the boot, thereby holding the boot on the hoof.

In one embodiment of the invention, the heel support also comprises a back plate and a heel cradle slidably coupled to the back plate for vertical adjustment of the cradle. A second fastener is used for fixing the cradle to the back plate at a desired height position. The strap fastener extends forward from the cradle and includes two straps attached to the front portion of the shell using buckles or other retention devices.

In another embodiment of the invention, the heel support includes forward projecting bands fastened to the rear portion of the shell, thereby defining bulb retaining openings. The strap fastener comprises a single strap wrapped around the front portion of the hoof and attached to each of the bands of the heel support.

The slot in the sole may be open, thereby defining an open groove notched into the upper surface of the sole, or closed, so as to define a channel within the sole, in either case conforming to the size and shape of the heel-support plate to be coupled to it. The plate is caused to slide to the required longitudinal position within the slot so as to provide the desired boot length and then fastened to the sole with appropriate fasteners anchored to it. Based on performance and manufacturing considerations, the closed-slot embodiment is currently preferred.

Various other advantages will become clear from the description of the invention in the specification that follows and from the novel features particularly pointed out in the appended claims. Therefore, this invention includes the features hereinafter illustrated in the drawings, fully described in the detailed description of the preferred embodiments and particularly pointed out in the claims, but such drawings and description disclose only some of the various ways in which the invention may be practiced.

### BRIEF DESCRIPTION OF THE DRAWINGS

FIG. 1 is a perspective view of the shell of a horse boot of the type to which the heel support of the invention can be coupled.

FIG. 2 is a perspective bottom view of the horse boot shell of FIG. 1.

FIG. 3 shows the heel support provided for coupling to the shell of the boot according to the invention.

FIG. 4 is a perspective view of the structure provided for coupling the heel support of the boot according to the invention.

FIG. 5 is a perspective front view of the components of FIGS. 3 and 4 after assembly with the addition of straps connected to the upper of the boot.

FIG. 6 is a perspective rear view of the boot of FIG. 5.

FIG. 7 is a perspective top view of the boot of FIG. 5.

FIG. 8 shows a layer of padding material added to the interior surface of the heel retaining structure of the boot of FIG. 5.

FIG. 9 shows in front view the boot of FIG. 8 mounted on a hoof.

FIG. 10 is a side view of FIG. 9.

FIG. 11 is a back view of FIG. 9.

FIG. 12 shows a second embodiment of the boot of the invention where the heel support and the cradle are combined into a single component.

FIG. 13 is a side view of the boot after the cradle structure is combined with the shell of the boot, thereby producing a bulb-cradle structure.

FIG. 14 is a rear view of the boot including a strap for wrapping around the hoof from the bands that define the bulb-cradle structure.

FIG. 15 is a side view of the boot of FIG. 14.

FIG. 16 illustrates the boot of FIG. 15 installed on the hoof of a horse.

FIG. 17 is a rear view of FIG. 16.

FIG. 18 illustrates the flexibility of the cradle structure seen in FIG. 17.

FIG. 19 shows in perspective view the preferred embodiment of the boot showing a closed slot in the sole for engaging the heel support of the invention.

FIG. 20 is a rear view of the shell of FIG. 19.

FIG. 21 is a side view of the heel support of the invention partially inserted into the closed slot of the shell of the boot.

FIG. 22 shows the heel support of the invention inserted to the intended position in the shell of the boot.

FIG. 23 shows the retaining bolts coupled to the heel support of the invention from the bottom of the sole of the boot and FIG. 24 illustrates the boot installed on the hoof of a horse.

### DETAILED DESCRIPTION OF THE PREFERRED EMBODIMENTS

As used herein, the term “sole” is defined to refer only to that part of a horse boot that covers entirely the underside of the hoof of a horse. By contrast, the term “horseshoe” is defined to refer to a structure, made of any material, substantially in the form of a conventional horseshoe with an open heel and an interior open area corresponding substantially to the interior underside of the hoof of a horse. Sometime such a horseshoe structure is connected to an upper to form a horse shoe or boot.

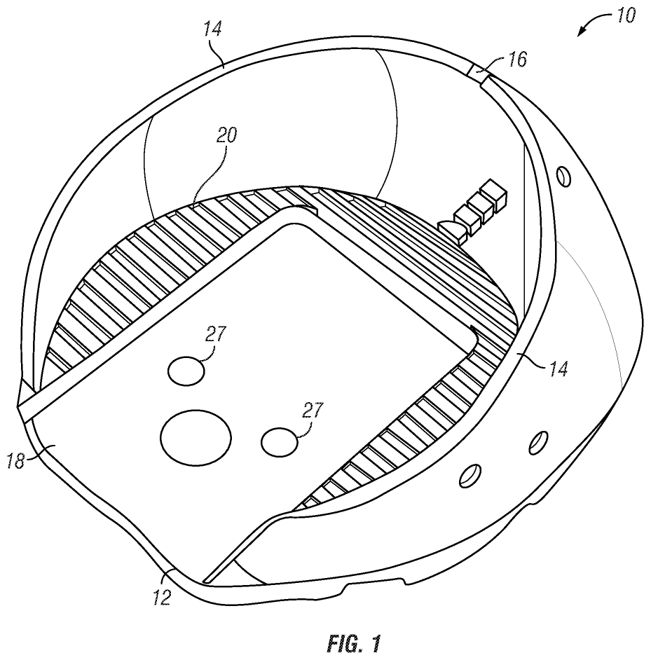

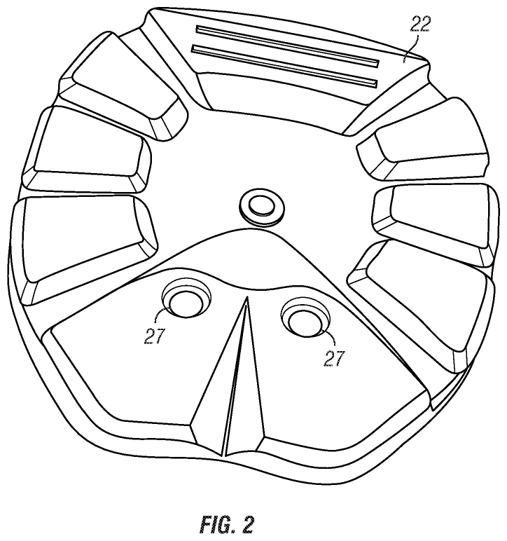

Referring to FIGS. 1 and 2, a horse boot according to the invention comprises a shell 10 composed of a sole 12 and an integrally formed upper with two sidewalls 14 of decreasing height toward the back of the shell. A slit 16 is preferably provided between the sidewall for lateral flexibility of the boot. The shell 10 is open in the back (i.e., the upper sidewalls 14 do not wrap around the back of the shell) and the sole 12 features an open longitudinal slot 18 defined by a horseshoe-like structure 20 around the front and lateral top periphery of the sole. The bottom side 22 of the sole 12 is preferably treaded conventionally for traction, as illustrated in FIG. 2.

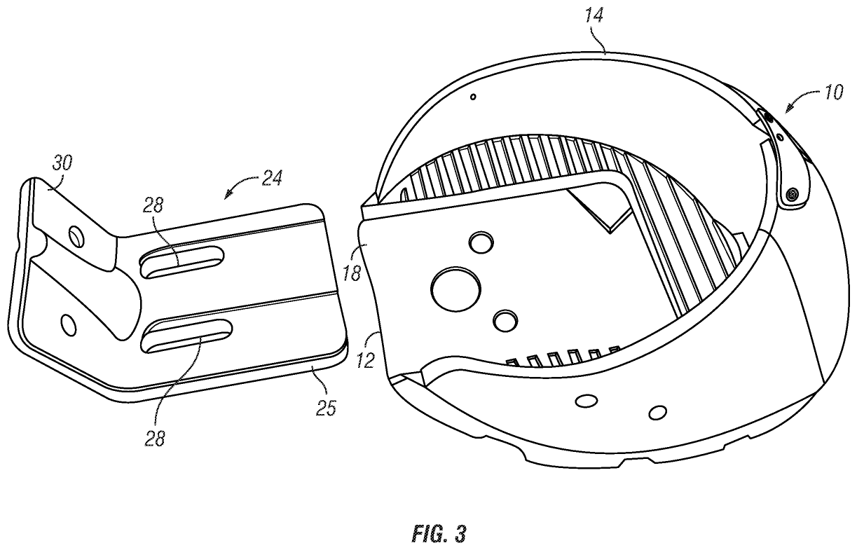

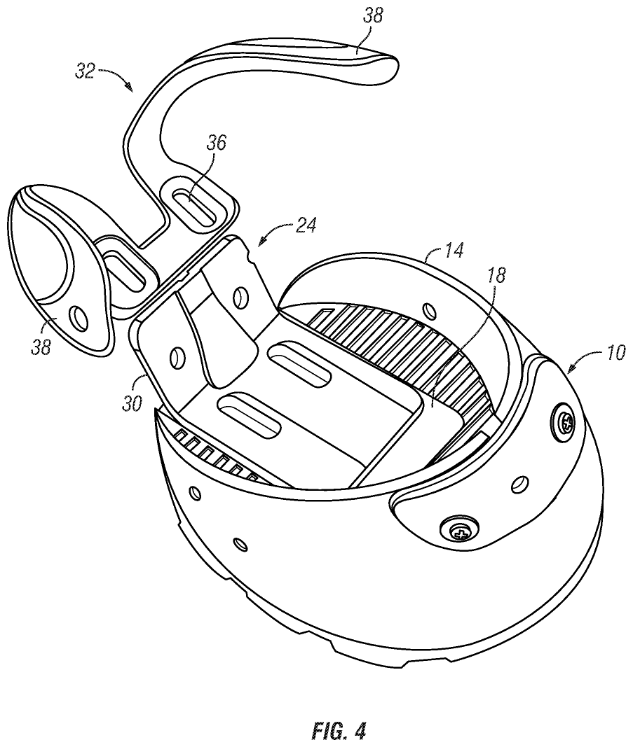

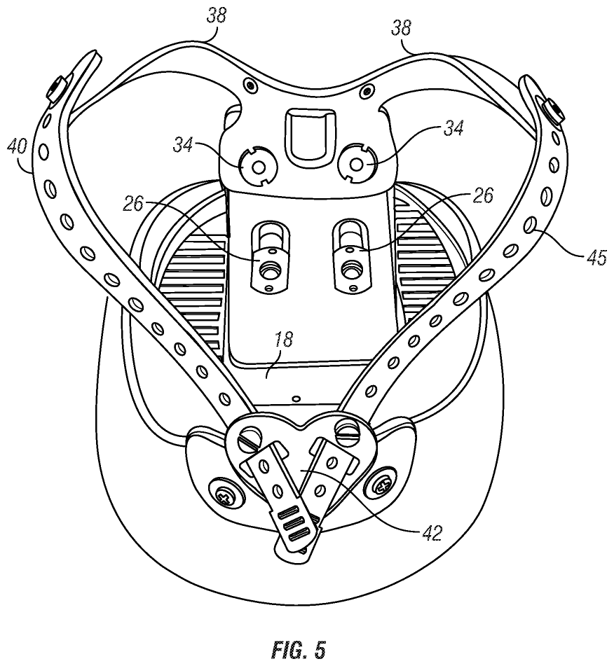

With reference to FIG. 3, according to one aspect of the invention, the horse boot includes a heel support 24 that is mounted slidably within the slot 18 in the sole 12, as shown in FIG. 4, so that the position of the support can be adjusted along the longitudinal dimension of the boot to change its length for the use at hand. To that end, the support 24 features a horizontal portion in the form of a bottom plate 25 that conforms to the slot 18 and is attached to it by means of typical retaining anchors 26 (such as the T-nuts seen in FIG. 5) affixed to the sole through apposite holes 27 (see FIG. 2) and tightened to the plate through adjustment grooves 28 in the plate. FIG. 5 shows the heel support 24 affixed to the sole of the boot at a particular longitudinal position deemed to meet the appropriate boot length for the intended use. The heel support 24 also features a back plate 30 for comfortably butting against the heel of the hoof when the support is positioned in place along the slot 18 of the boot's sole.

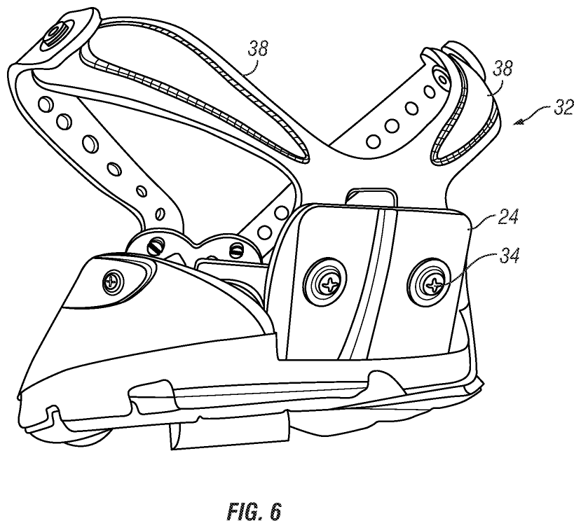

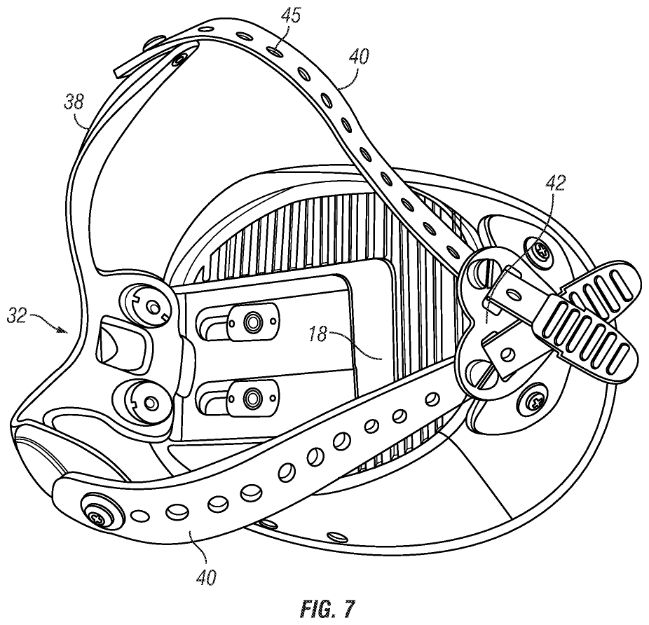

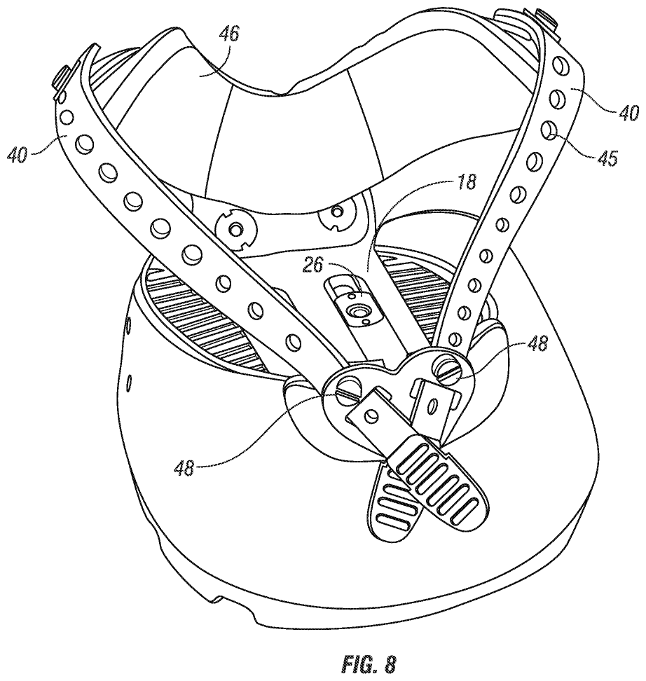

According to another aspect of the invention illustrated in FIGS. 4 and 5, a heel cradle 32 is coupled to the back plate 30 of the heel support 24. The vertical slant position of the cradle 32 in the boot is preferably rendered slidably adjustable by attaching it by means of retaining anchors 34 affixed to the back plate 30 and tightened on the cradle 32 through adjustment grooves 36 (see FIGS. 4, 5 and 6). Two lateral bands 38 of the cradle extend forward for wrapping around the upper portion of the hoof where its diminishing horizontal cross-section defines side shoulders for advantageously strapping the boot to the hoof (basically along the lateral portions of the coronary band between the hoof and the pastern). Straps 40 connected to the bands 38 are fastened to the front of the boot's upper to hold the boot in place on the hoof. Each strap 40 can be part of an extended band 38 as a single unitary structure. A rigid double buckle structure 42 attached to the front of the upper can be used to tighten the straps 40 through holes 45 in belt-like manner, as seen in FIG. 7. The buckle structure 42 is anchored to the upper of the shell 10 by means of a bolt 43 attached to a resilient pad 46 that is in turn similarly affixed to both sides of the slit 16 between the two side-walls 14 of the upper. The pad 46 is sufficiently resilient to allow the expansion of the slit 16 during the installation and use of the boot but also strong enough to hold the strapped boot in place. Elastomer polymers such as ethylene-vinyl acetate (EVA) materials have been found to be suitable for it (available commercially under the generic name EVA). A layer of padding material 46 can be attached to the interior back surface of the cradle 32 for more comfortable wear, as shown in FIG. 8. A preferred material for this pad is neoprene.

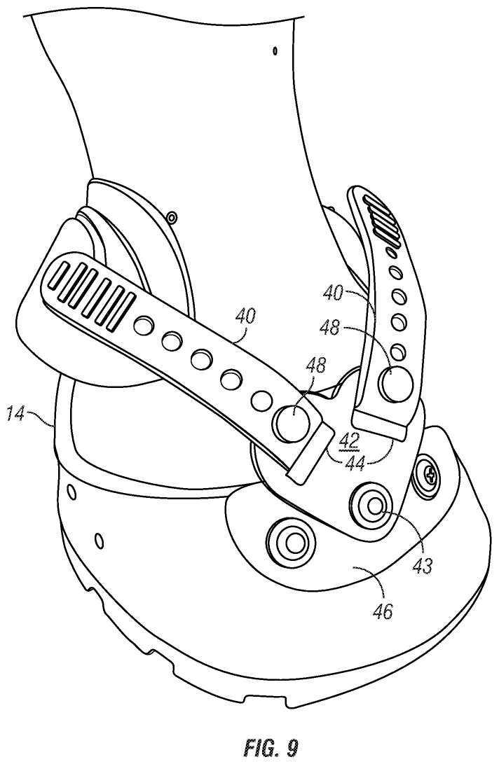

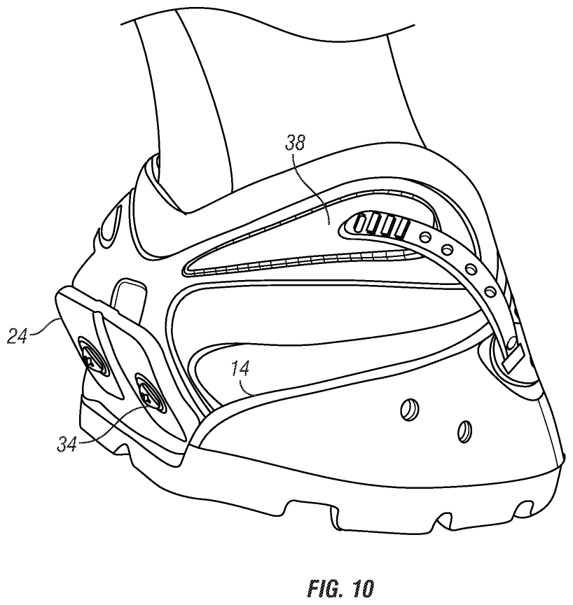

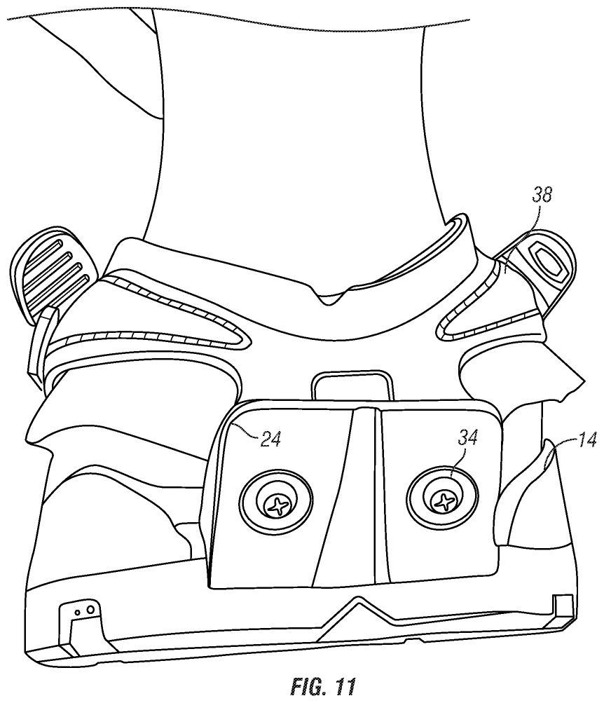

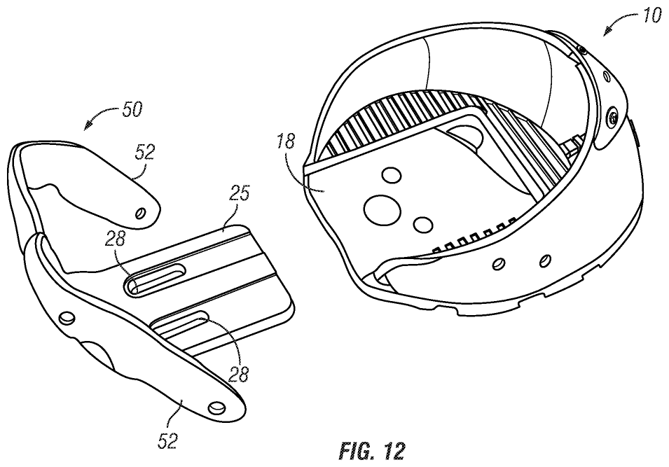

In use the boot is installed in conventional manner by spreading open the sidewalls 14 of the upper, slipping the boot onto the hoof from the front, and sliding the bottom plate 25 of the heel support 24 along the slot 18 in the sole so as to cause the back plate 30 to butt against the heel of the hoof in the desired longitudinal position. The plate 25 is then secured in that position and, with the hoof in place, the vertical position of the heel cradle 32 along the back plate 30 is found that affords the optimal horizontal alignment of the bands 38 with the shoulder areas between the hoof and the pastern on each side of the boot. The cradle 32 is then secured at that height and the boot is finally installed by passing the straps 40 through their respective buckle apertures 44 at the front of the boot shell and securing them by inserting each buckle's catch 48 into the appropriate hole 45 of each strap 40. FIGS. 9, 10 and 11 illustrate the boot of the invention installed on the hoof of a horse.

For the best adjustment position of the heel cradle 32 within the slot 18 of the boot shell, I found that the holes 27 in the sole should be placed such that the back edge of the holes is at least 15 mm and up to 60 mm from the back of the sole, 15 mm being optimal. This placement ensures that the heel cradle can pivot upward with the lift of the heel.

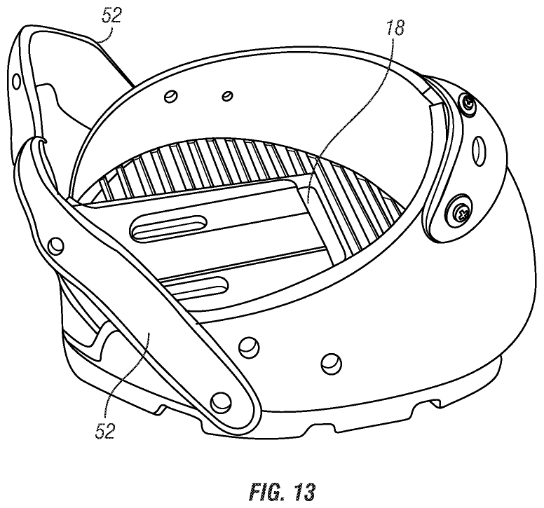

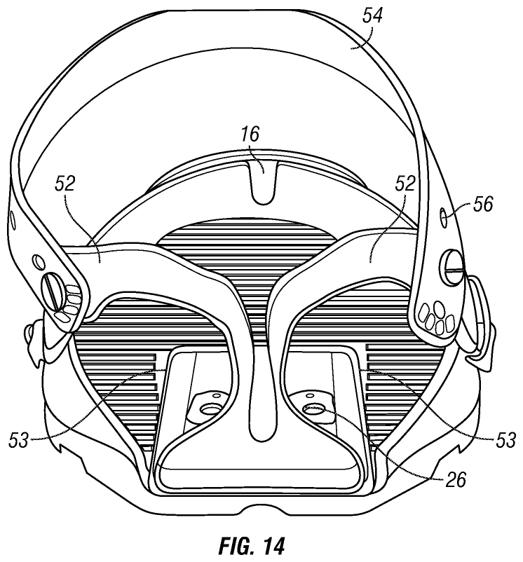

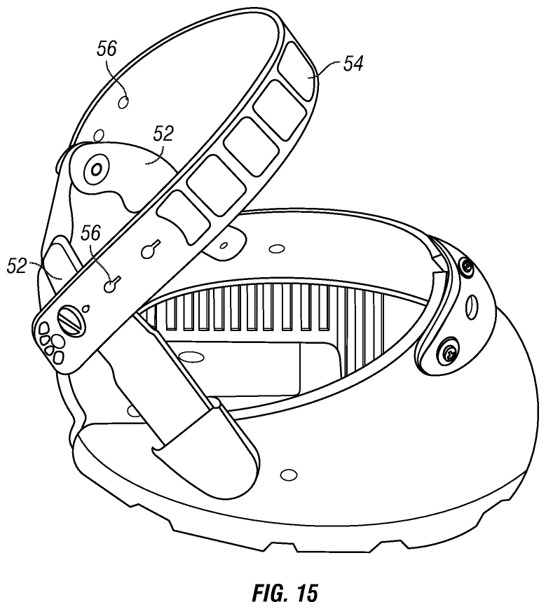

According to another embodiment of the invention, the heel support and the cradle of the invention are combined into an integral single component. As illustrated in FIG. 12, the shell 10 remains the same with a sole 12 that features a longitudinal slot 18 defined by a horseshoe-like structure 20 in the sole. The back portion of this embodiment of the invention amounts to a heel cradle structure 50 that includes the same bottom plate 25 that conforms to the slot 18 and is attached to it by means of retaining anchors 26 affixed to the sole 12 and tightened on the plate 25 through adjustment grooves 28 in the plate, as seen in FIGS. 13 and 14. Because the plate 25 is mounted slidably within the slot 18 of the sole 12, the longitudinal position of the cradle structure 50 can be adjusted to change the length of the boot, as in the first embodiment.

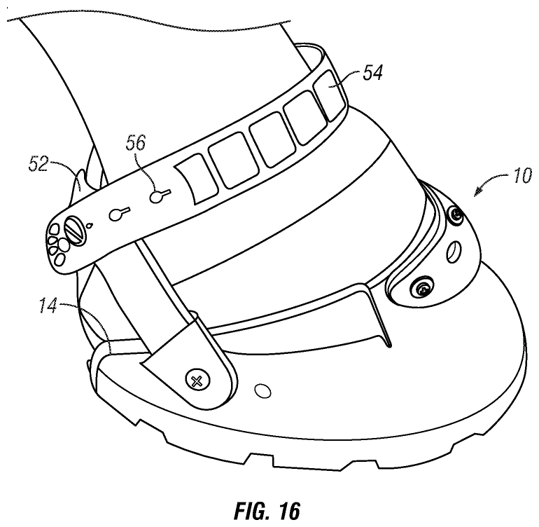

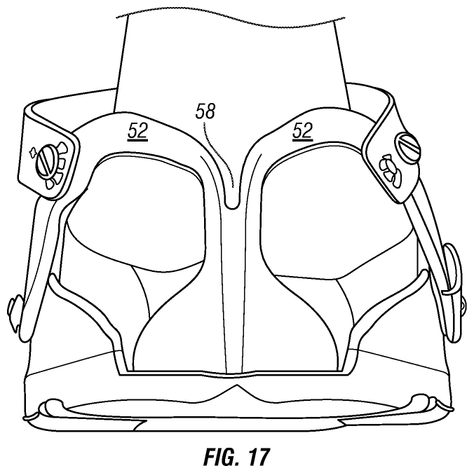

The cradle structure 50 also includes two lateral bands 52 that extend forward. However, rather than being connected to the shell 10 in the front of the boot as in the first embodiment, the bands 52 are connected to the rear portion of the upper, as seen in FIG. 13, thereby defining two openings 53 (FIG. 14) designed to receive and support the bulbs of the horse's hoof. As seen more particularly in FIG. 14, the bands 52 are sized and shaped such that they circumscribe each bulb from the center back of the heel for containment and support of the hoof. A single strap 54, appropriately tied to both bands 52, is then used to wrap around the hoof of the horse at the coronary band level. Multiple holes 56 on each end of the strap 54 for attaching to the bands 50 afford flexibility in ensuring that the boot is firmly secured to the hoof. FIGS. 15 and 16 illustrate the assembled boot according to this second embodiment stand-alone and installed on the hoof of a horse, respectively.

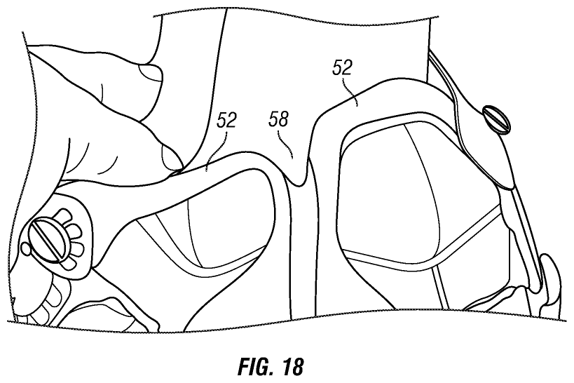

Of particular interest in this embodiment of the invention is the deformable heel cradle structure that results from providing two bands 52 that are folded downward from their initial upward position. As seen in FIGS. 17 and 18, the V-shaped opening 58 so formed in the upper back of the cradle structure 50 renders the cradle advantageously flexible to absorb stresses on the boot caused by bad terrain and other unfavorable conditions without separation of the boot from the hoof of the horse. FIG. 18 illustrates such flexibility and stability of the boot of the invention.

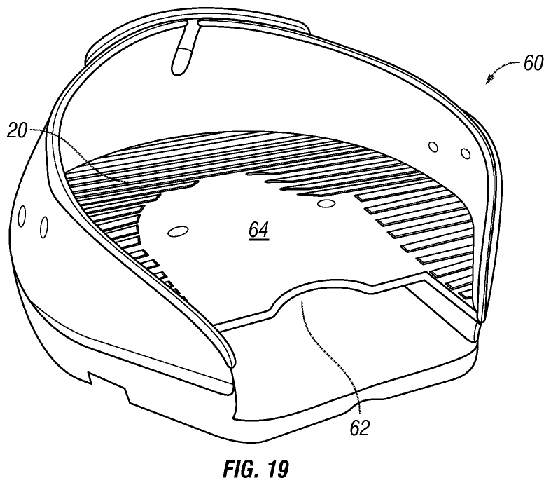

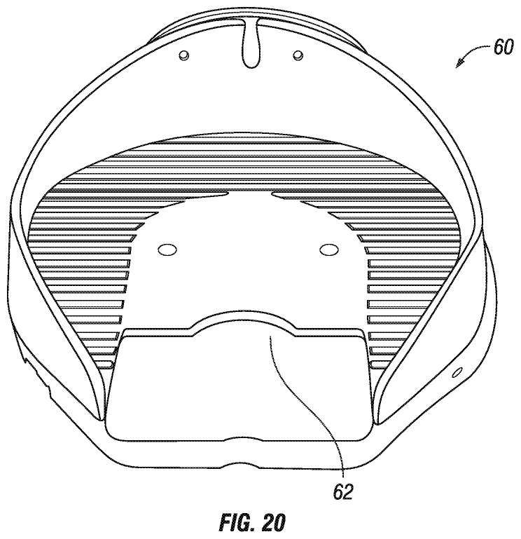

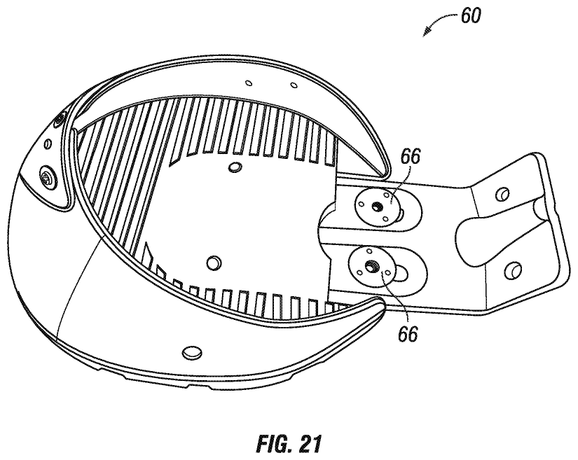

Because the slot 18 is open, the plate 25 and the metal retaining anchors 26 are necessarily in contact with the frog of the hoof, which can be irritating to the horse. Therefore, another, preferred embodiment of the invention shown in FIGS. 19 and 20 features a shell 60 equal in all respects to the shell 10 of FIG. 1 with the exception of the slot receiving the heel support 24 of the invention. Instead of the open slot 18 of FIG. 1, the shell 60 features a closed slot 62 defined by a plate 64 coplanar with the horseshoe-like structure 20 of the shell. As a result, the hoof of the horse is insulated from any metal surface.

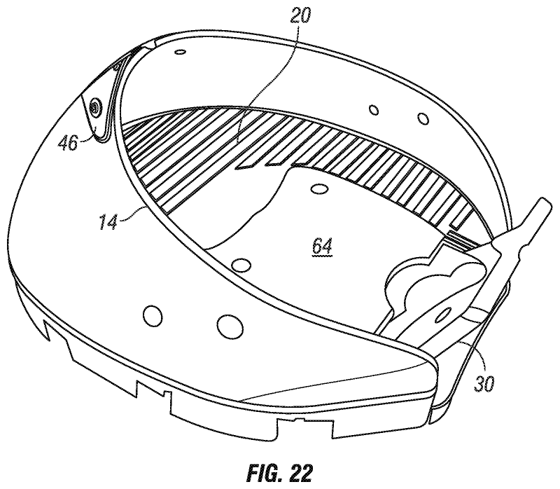

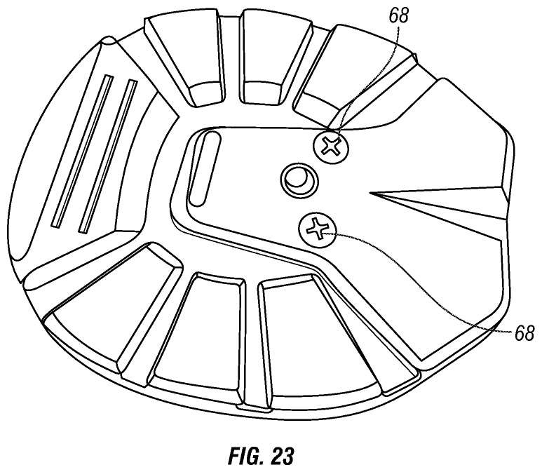

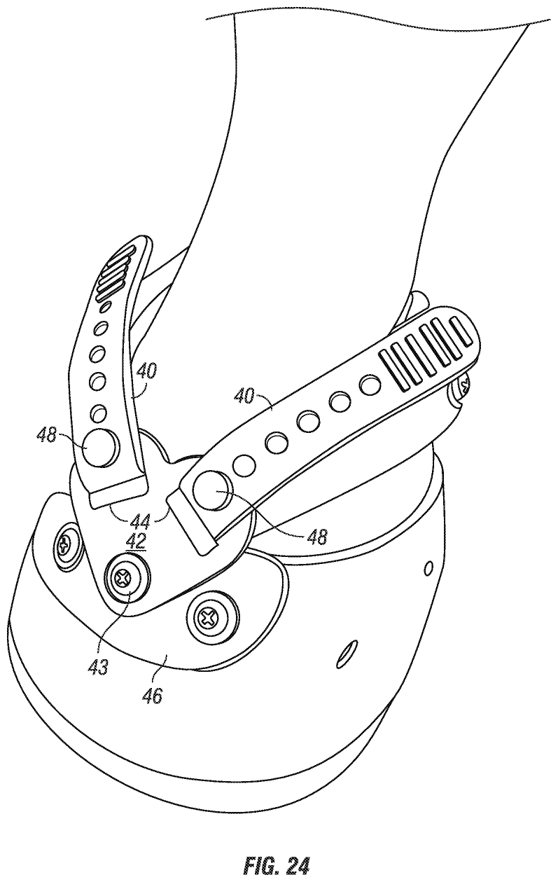

FIG. 21 shows the heel support 24 partially inserted in the slot 62 with T-nuts 66 placed in the adjustment grooves 28 (see also FIG. 3) for securing the bottom plate 25 to the shell 60 with bolts inserted through the bottom of the sole. FIG. 22 illustrates a fully inserted heel support 24 with the T-nuts 66 covered by plate 64 thereby protecting the hoof from potential irritation. FIG. 23 shows the bottom of the sole of the shell 60 to illustrate the bolts 68 coupled to the T-nuts 66 in the grooves 28 of the heel support. Every other feature of the invention, whether in the embodiment of FIGS. 1-11 or the embodiment of FIGS. 12-18 is obviously also available with the shell 60 of FIGS. 19-24.

Thus, a horse boot has been disclosed that can be fitted while adjusted in length and height to optimize the way it is fastened to the hoof of the horse. As a result, the boot has proven to be very stable and resilient to detachment while in use. The boot also has no fastening mechanism structure that protrudes laterally from the upper of the boot, thereby avoiding the common problem of boots coining off because of interference with other boots worn by the horse.

While the invention has been shown and described herein with reference to what are believed to be the most practical embodiments, it is recognized that departures can be made within the scope of the invention. For example, the connection between the adjustable plate 25 and the sole 12 has been described in terms of retaining anchors 26, but any equivalent fastener would be suitable to practice the invention. The bands and straps of the invention are illustrated for convenience as tied to each other and to the upper of the boot by means of nuts and bolts and buckles; however, it is anticipated that other retention devices, such as hook and loop strips, may be equally practical. Similarly, the straps and bands of the first embodiment could be made of unitary construction as extensions of the straps described in the figures. Therefore, the invention is not to be limited to the details disclosed herein but is to be accorded the full scope of equivalent articles.

I claim:

1. A horse boot comprising:
a shell that includes a sole and an upper with sidewalls extending upward from front and lateral edges of the sole, said sole having a longitudinal slot and having an open rear end for access to said slot;
a heel support that includes a plate adapted for slidable engagement with the slot in the sole;
a first fastener for fixing the plate to the sole at a desired length position along a longitudinal dimension of the boot; and
a strap fastener adapted to hold the boot on the hoof.

2. The boot of claim 1, wherein said slot is an open slot in a top surface of the sole.

3. The boot of claim 2, wherein said heel support comprises a back plate and a heel cradle slidably coupled to the back plate for vertical adjustment of the cradle; and a second fastener for fixing the cradle to the back plate at a desired height position.

4. The boot of claim 3, wherein said strap fastener extends forward from said cradle.

5. The boot of claim 4, wherein said strap fastener includes two straps attached to a front portion of the shell.

6. The boot of claim 5, wherein said two straps are attached to the front portion of the shell by means of buckles.

7. The boot of claim 2, wherein said heel support includes forward projecting bands fastened to a rear portion of the shell, thereby defining bulb retaining openings.

8. The boot of claim 7, wherein said strap fastener comprises a strap wrapped around a front portion of the hoof and attached to each of said bands of the heel support.

9. The boot of claim 1, wherein said slot is a closed slot in the sole.

10. The boot of claim 9, wherein said heel support comprises a back plate and a heel cradle slidably coupled to the back plate for vertical adjustment of the cradle; and a second fastener for fixing the cradle to the back plate at a desired height position.

11. The boot of claim 10, wherein said strap fastener extends forward from said cradle.

12. The boot of claim 11, wherein said strap fastener includes two straps attached to a front portion of the shell.

13. The boot of claim 12, wherein said two straps are attached by means of buckles.

14. The boot of claim 9, wherein said heel support includes forward projecting bands fastened to a rear portion of the shell, thereby defining bulb retaining openings.

17. The boot of claim 14, wherein said strap fastener comprises a strap wrapped around a front portion of the hoof and attached to each of said bands of the heel support.

18. A method of fitting a horse boot on a hoof, comprising the following steps:
providing a horse boot that comprises a shell that includes a sole and an upper with sidewalls extending upward from front and lateral edges of the sole, said sole having a longitudinal slot and having an open rear end for access to said slot; a heel support that includes a plate adapted for slidable engagement with the slot in the sole; a first fastener for fixing the plate to the sole at a desired length position along a longitudinal dimension of the boot; and a strap fastener adapted to hold the boot on the hoof;
spreading open the sidewalls of the upper;
slipping the horse boot onto the hoof through said open rear end of the sole;
sliding the plate of the heel support along said slot in the sole;
fixing the plate to the sole at a desired length position along a longitudinal dimension of the boot using said first fastener; and
fastening the boot on the hoof with said strap fastener.

19. The method of claim 18, wherein said heel support comprises a back plate and a heel cradle slidably coupled to the back plate for vertical adjustment of the heel cradle, and a second fastener for fixing the heel cradle to the back plate at a desired height position; and wherein the method further comprises the steps of:
sliding the heel cradle to a desired height position along said back plate; and
fixing the heel cradle to the back plate at said desired height position using the second fastener.

20. The method of claim 19, wherein said heel support includes forward projecting bands fastened to a rear portion of the shell, thereby defining bulb retaining openings, and said strap fastener comprises a strap wrapped around a front portion of the hoof and attached to each of said bands of the heel support.
